(19) United States
(12) Patent Application Publication
(10) Pub. No.: US 2018/0208492 A1
(43) Pub. Date: Jul. 26, 2018

(54) LARGE MELTING KILN SUITABLE FOR BOROSILICATE GLASS

(71) Applicant: CHINA TRIUMPH INTERNATIONAL ENGINEERING CO., LTD., SHANGHAI (CN)

(72) Inventors: SHOU PENG, SHANGHAI (CN); QING LIU, SHANGHAI (CN); LONGYUE JIANG, SHANGHAI (CN); YANPING CAO, SHANGHAI (CN); XIAOLONG WANG, SHANGHAI (CN)

(73) Assignee: CHINA TRIUMPH INTERNATIONAL ENGINEERING CO., LTD., SHANGHAI (CN)

(21) Appl. No.: 15/511,840

(22) PCT Filed: Apr. 29, 2015
(86) PCT No.: PCT/CN2015/077769

§ 371 Date: Sep. 8, 2017

(30) Foreign Application Priority Data
Sep. 16, 2014 (CN) 201410470089.8

(51) Int. Cl. C03B 5/027; C03B 5/193; C03B 5/235

(52) U.S. Cl. CPC C03B 5/027; C03B 5/2353; C03B 5/193

(57) ABSTRACT

A large melting furnace suitable for borosilicate glass. Which has a melting area, a reinforcing area, an ascending area and a clarifying area. The melting area and the reinforcing area are separated by a partition wall, and a lower end of the partition wall goes deep below a surface of molten glass but is not in contact with a bottom of the melting furnace, so as to guarantee that the molten glass in the two areas is interconnected. The structures of the melting area and reinforcing area can also improve the problem of boron volatilization of the borosilicate glass caused by flame melting during a melting process. The molten glass flows out from a throat of the reinforcing area, passes through the ascending area and enters the shallower clarifying area.

### FIELD OF THE INVENTION

The present invention relates to a technical field of glass melting equipment, and in particular to a melting furnace suitable for borosilicate glass. The melting furnace is characterized by combining electric melting and flame melting, has a special structural design, and is a borosilicate glass melting furnace having a large production capacity.

### BACKGROUND

Borosilicate glass has features such as high viscosity, high melting temperature, boron volatility and boron and silicon phase splitting. If a single flame melting mode is used and heating is performed by virtue of spatial radiation, not only heating efficiency will be lower and melting effect will be poor when melting glass which is very difficult to melt, but also the disturbance of flame will increase the amount of volatilized boron.

The full-electric melting technique is used for small glass melting furnaces having a production capacity below 15 t/d, is an economic and applicable melting process and is particularly applicable to glass having highly-volatile components, glass having high melting temperature and special glass. At present, for borosilicate glass, this type of small full-electric melting furnace is mainly used for producing some glass products which are not produced in a mass, such as glass utensils, glass tubes and glass rods. To view from practical production experiences, for the full-electric melting furnaces having a production capacity above 20 t/d, since the number of electrodes is increased, current distribution is more complex during a melting process, the uniformity of molten glass is poorer and the number of stripes in glass products is greater.

For borosilicate glass, especially high borosilicate glass, since thermal properties thereof are excellent, the application field thereof is increasingly wide. Particularly, panel borosilicate glass is used in various fields such as glass substrates, instrument glass, heat-resistant glass windows and flameproof glass. In order to satisfy the requirements of high-capacity panel glass formation process, the production capacity of a melting furnace has to match therewith.

However, regarding the problem of boron volatilization brought about by reducing flame combustion, to view from the mechanism of boron volatilization, during a process that powder batch is converted into molten glass, the batch containing boron is decomposed once heating and reacts with other oxides in the batch to form various compounds having a higher melting point. During this process, a great amount of gas and water is discharged from the batch with the increase of temperature and the proceeding of reaction, boron oxide is volatilized therewith and the amount of volatilized boron accounts for about 91% of the whole-process volatilization amount. However, when a great amount of molten glass is produced, high-viscosity molten glass causes the speed that boron oxide is diffused to the surface to become very low, the amount of volatilized boron oxide at this stage only accounts for about 9% of the whole-process volatilization amount. Therefore, in order to decrease the volatilization of boron oxide, a melting area should adopt a cold heading mode, and flame combustion has to be fully separated from the powder batch.

Accordingly, it can be seen that high-quality borosilicate molten glass can be obtained by adopting a large melting furnace, as long as a suitable melting furnace structure is adopted, the volatilization of boron oxide during the process that the borosilicate batch is converted into molten glass is avoided and the uniformity of the molten glass is increased.

### SUMMARY

The purpose of the present invention is providing a large melting furnace for borosilicate glass, which is combined with the advantages of flame melting and electric melting techniques and is a melting furnace having a production capacity above 20 t/d.

In order to achieve the above-mentioned purpose, a large melting furnace suitable for borosilicate glass is provided. The melting furnace is provided with a melting area, a reinforcing area, an ascending area and a clarifying area. The melting area and the reinforcing area are separated by a partition wall, and a lower end of the partition wall goes deep below a surface of molten glass but is not in contact with a bottom of the melting furnace, so as to guarantee that the molten glass in the two areas is interconnected.

In some embodiments, the reinforcing area adopts a mixed heating mode, wherein flame heating is adopted for a surface of the molten glass and electrode heating is adopted for a bottom of the melting furnace.

In some embodiments, the flame heating is full-oxygen combustion, oxygen-supported combustion or air combustion.

In some embodiments, the electrode heating comprises arranging heating electrodes at a bottom of the melting area.

In some embodiments, the molten glass enters the ascending area through a throat at a bottom of a tail end of the reinforcing area.

In some embodiments, the ascending area is provided with a homogenization device.

In some embodiments, the homogenization device is a bubbling device, a mechanical mixing device or an ultrasonic device.

In some embodiments, the clarifying area is shallower than the melting area, the reinforcing area and the ascending area.

In some embodiments, an electric heating and negative pressure system is arranged in a space above the surface of the molten glass.

In some embodiments, the electric heating and negative pressure system in the clarifying area adopts silicon-carbon rods for heating the surface of the molten glass, and adopts a mechanical air exhaust mode to guarantee a negative pressure state of the clarifying area.

According to the large melting furnace suitable for borosilicate glass, the structures of the melting area and reinforcing area can also improve the problem of boron volatilization of the borosilicate glass during a melting process caused by flame melting. The molten glass flows out from the throat of the reinforcing area, passes through the ascending area and enters a shallower clarifying area. By means of the homogenization device arranged in the ascending area and the electric heating and negative pressure system arranged in the clarifying area, the molten glass is sufficiently homogenized and clarified.

The present invention will be described below through examples with reference to the drawings, such that other aspects and advantages of the present invention can be clearly understood.

### BRIEF DESCRIPTION OF THE DRAWINGS

With reference to the drawings, through the detailed description below, the above-mentioned and other features and advantages of the present invention can be more clearly understood, wherein:

FIG. 1 illustrates an elevation view of a borosilicate glass melting furnace according to a embodiment of the present invention; and

FIG. 2 illustrates a plan view of a borosilicate glass melting furnace according to a embodiment of the present invention.

### DETAILED DESCRIPTION OF THE PREFERRED EMBODIMENTS

With reference to the specific embodiments and drawings of the present invention, the present invention will be described below in more detail. However, the present invention may be implemented in many different modes and shall not be understood as limited by the embodiments provided herein. Contrarily, these embodiments are provided in order to achieve full and complete disclosure and allow one skilled in the art to fully understand the scope of the present invention.

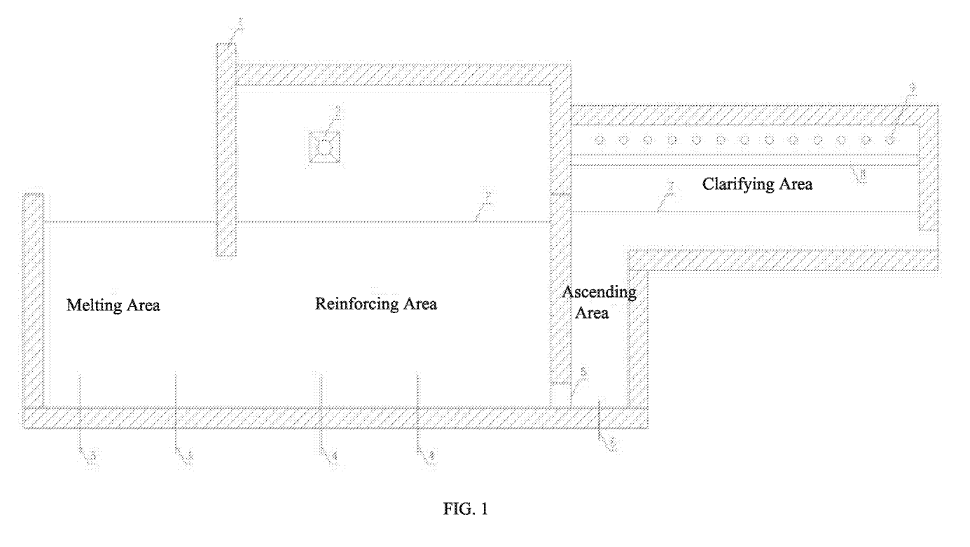

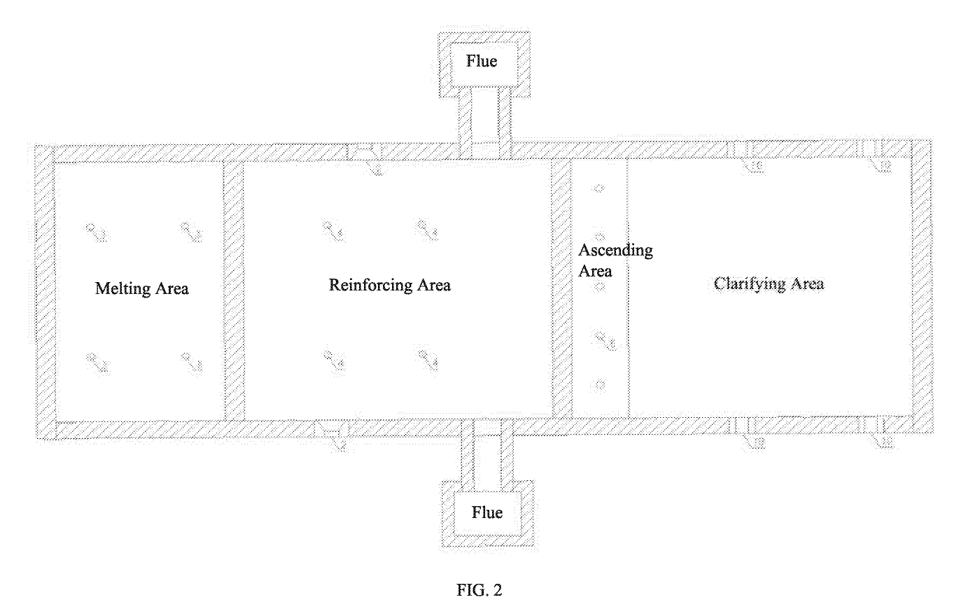

Now, with reference to FIG. 1 and FIG. 2, the large melting furnace suitable for borosilicate glass according to the embodiment of the present invention will be described in detail.

As illustrated in FIG. 1 and FIG. 2, the melting furnace is provided with a melting area, a reinforcing area, an ascending area and a clarifying area. The melting area and the reinforcing area are separated by a partition wall, and a lower end of the partition wall goes deep below a surface of molten glass but is not in contact with a bottom of the melting furnace, so as to guarantee that the molten glass in the two areas is interconnected.

In some embodiments, the reinforcing area adopts a mixed heating mode, wherein flame heating is adopted for a surface of the molten glass, and electrode heating is adopted for a bottom of the melting furnace. The flame heating may be full-oxygen combustion, oxygen-supported combustion or air combustion. The electrode heating comprises arranging heating electrodes at a bottom of the melting area.

In some embodiments, the molten glass enters the ascending area through a throat at a bottom of a tail end of the reinforcing area. The ascending area is provided with a homogenization device. The homogenization device may be a bubbling device, a mechanical mixing device or an ultrasonic device. The clarifying area is shallower than the melting area, the reinforcing area and the ascending area.

In some embodiments, an electric heating and negative pressure system is arranged in a space above the surface of the molten glass. The electric heating and negative pressure system in the clarifying area adopts silicon-carbon rods for heating the surface of the molten glass, and adopts a mechanical air exhaust mode to guarantee a negative pressure state of the clarifying area.

A full-oxygen combustion mode is selected for the flame melting part in this embodiment, and as illustrated in the drawings, the melting furnace is divided into a melting area, a reinforcing area, an ascending area and a clarifying area, wherein two smoke exhaust flues are arranged at two sides of a furnace body in the reinforcing area.

The melting area and the reinforcing area of the melting furnace provided by the present invention is separated by a partition wall 1 near level line 7, and the insertion depth into the molten glass level line 7 can be adjusted by the partition wall 1. Below the partition wall 1, the melting area and the reinforcing area are interconnected.

An open feed inlet is provided above the melting area, powder batch is uniformly fed above the molten glass in the melting area through a feeder, heating electrodes 3 are arranged at a bottom of the melting area, the power of the heating electrodes 3 must guarantee that a surface of the melting area is covered with a thicker powder batch layer, and temperature of the surface of the powder batch layer is as low as possible to enable boron oxide volatilized from the molten glass in the melting area to be condensed in the batch covering layer and to flow back into the molten glass, such that the volatilization of boron oxide is decreased.

A bottom of the melting furnace in the reinforcing area is heated from the bottom thereof by adopting electrodes 4, a flame combustion spray gun opening 2 is arranged at a sidewall of the melting furnace and is used for erecting a full-oxygen spray gun. Flame heating is adopted in a space above the level line 7. A mode combining electrode hating and flame heating improves the melting quality of the molten glass increased the uniformity of the molten glass and is suitable for a melting furnace having a great production capacity. Since the partition wall 1 separates the flame space from the powder batch, the disturbance caused by flame combustion to the powder batch is decreased and thus the volatilization of boron oxide is decreased. Flues at the two sides of the melting furnace are used for exhausting waste gas produced during flame combustion.

The molten glass in the reinforcing area passes through a throat 5 between the reinforcing area and the ascending area and enters the ascending area. The throat 5 is located at a position close to the bottom of the melting furnace. A bubbling device 6 is arranged at a bottom of the ascending area to decrease the accumulation of aluminum elements having a larger proportion at a dead corner of the ascending area during the fluxion of the molten glass, and to increase the uniformity of the molten glass.

The ascending area and the clarifying area are located in a comparatively close space, and the clarifying area is shallower. A depressurization device is arranged at a mechanical air exhaust outlet 10 at the sidewall of the melting furnace in the clarifying area to reduce the pressure in the space above the molten glass level line 7 in the ascending area and the clarifying area and accelerate the exhaust of air bubbles in the molten glass. Besides, a partition plate 8 is arranged in the space above the molten glass level line 7 in the ascending area and the clarifying area, and silicon-carbon rods 9 are used above the partition plate 8 for performing radiation heating to the molten glass, so as to reduce the viscosity of the molten glass and accelerate the exhaust of the air bubbles in the molten glass.

According to the large melting furnace suitable for borosilicate glass provided by the embodiment of the present invention, the structures of the melting area and reinforcing area can also improve the problem of boron volatilization of the borosilicate glass caused by flame melting during the melting process. The molten glass flows out from the throat of the reinforcing area, passes through the ascending area and enters the shallower clarifying area. By means of the homogenization device arranged in the ascending area and the electric heating and negative pressure system arranged in the clarifying area, the molten glass is sufficiently homogenized and clarified.

The preferred specific embodiments of the present invention are described above in detail. It should be understood that various modifications and variations may be made by one skilled in the art according to the concept of the present invention without contributing any inventive labor. All technical solutions, which can be obtained by one skilled in the art according to the concept of the present invention on the basis of the prior art through logical analysis, reasoning or limited tests, shall be included in the protection scope determined by the claims.

What is claimed is:

1. A large melting furnace suitable for borosilicate glass, characterized in that the melting furnace is provided with a melting area, a reinforcing area, an ascending area and a clarifying area, wherein,
The melting area and the reinforcing area are separated by a partition wall, and a lower end of the partition wall goes deep below a surface of molten glass but is not in contact with a bottom of the melting furnace, so as to guarantee that the molten glass in the two areas is interconnected.

2. The melting furnace according to claim 1, characterized in that the reinforcing area adopts a mixed heating mode, wherein flame heating is adopted for a surface of the molten glass and electrode heating is adopted for a bottom of the melting furnace.

3. The melting furnace according to claim 2, characterized in that the flame heating is full-oxygen combustion, oxygen supported combustion or air combustion.

4. The melting furnace according to claim 2, characterized in that the electrode heating comprises arranging heating electrodes at a bottom of the melting area.

5. The melting furnace according to claim 1, characterized in that the molten glass enters the ascending area through a throat at a bottom of a tail end of the reinforcing area.

6. The melting furnace according to claim 5, characterized in that the ascending area is provided with a homogenization device.

7. The melting furnace according to claim 6, characterized in that the homogenization device is a bubbling device, a mechanical mixing device or an ultrasonic device.

8. The melting furnace according to claim 1, characterized in that the clarifying area is shallower than the melting area, the reinforcing area and the ascending area.

9. The melting furnace according to claim 8, characterized in that an electric heating and negative pressure system is arranged in a space above the surface of the molten glass.

10. The melting furnace according to claim 9, characterized in that the electric heating and negative pressure system in the clarifying area adopts silicon-carbon rods for heating the surface of the molten glass and adopts a mechanical air exhaust mode to guarantee a negative pressure state of the clarifying area.
